(19) United States
(12) Patent Application Publication
(10) Pub. No.: US 2025/0314910 A1
(43) Pub. Date: Oct. 9, 2025

(54) SYSTEM AND METHOD FOR PRODUCTION OF POLYDIKETOENAMINE BASED RENEWABLE PLASTIC

(71) Applicant: FLO Materials, Inc., Santa Barbara, CA (US)

(72) Inventors: Kezi CHENG, Santa Barbara, CA (US); Peter R CHRISTENSON, Santa Barbara, CA (US); Alisa SHMIDT, Santa Barbara, CA (US)

(73) Assignee: FLO Materials, Inc., Santa Barbara, CA (US)

(21) Appl. No.: 18/860,482

(22) PCT Filed: Apr. 27, 2023
(86) PCT No.: PCT/US2023/066303

§ 371 Date: Oct. 25, 2024

Related U.S. Application Data
(60) Provisional application No. 63/335,665, filed on Apr. 27, 2022.

(51) Int. Cl. G02C 5/00; C08G 12/00

(52) U.S. Cl. CPC G02C 5/008; C08G 12/00

(57) ABSTRACT

A system, composition, and method of producing a heat resistant and higher toughness plastic material that results in enhanced Polydiketoenamines (PDK) materials. Such systems, compositions, and/or methods may include combination of a triketone and a plasticizer with other enhancing materials such as in one variation a heat resistant difunctional or trifunctional polyamine that forms dynamic covalent bonds with the triketone, or in another variation a diamine that acts as a chain extender and a triamine that acts as a cross-linking agent.

### CROSS-REFERENCE TO RELATED APPLICATIONS

This Application is a National Stage completion of PCT/US2023/066303 filed Apr. 27, 2023, which claims the benefit of U.S. Provisional Application No. 63/335,665, filed on 27 APR. 2023, which is incorporated in its entirety by this reference.

### TECHNICAL FIELD

This invention relates generally to the field of renewable plastics, and more specifically to a new and useful system and method for production of a polydiketoenamine based renewable plastic.

### BACKGROUND

Plastics are complex polymer compounds that have come to play an integral role in our society. Due to their highly modifiable properties, resilience, and ease of production so much of everything around us is made of plastic. A major problem with plastics is that although they are easy to produce, breakdown and reuse of most plastics is extremely difficult if not impossible. For example, while PDKs have been shown to be thermally processable, many formulations of PDKs begin to decompose when processed or used at temperatures >200° C. Existing formulations also lack toughness and elongation properties of high performance plastics. In addition, solid-liquid blending of solid triketones and liquid polyamines and plasticizers have shown to be inhomogeneously mixed through ball milling. Thus, there is a need in the field of plastics to create a new and useful system and method for renewable plastics. This invention provides such a new and useful system and method.

### BRIEF DESCRIPTION OF THE FIGURES

The patent or application file contains at least one drawing executed in color. Copies of this patent or patent application publication with color drawing(s) will be provided by the Office upon request and payment of the necessary fee.

FIG. 1 are sample images of PDKs with increasing TEC additives on the left to PDKs with increasing ETHX additives on the right.

FIG. 2 is a flowchart representation of one method variation.

FIG. 3 is a flowchart representation of another method variation.

FIG. 4 is a set of sample process images from ball milling.

FIG. 5 is a set of sample images related to PDK polymerization facilitated by liquid solvent method.

FIG. 6 is a set of chemical diagrams for triketone, T-Series polyamine, and D-Series polyamine.

FIG. 7 is a chart showing TGA of various monomers.

FIG. 8 is a set of sample images showing original PDK formulation yellowing and degrading at high temperatures.

FIG. 9 are representative charts of enhanced thermal stability (left) and performance under elongation (right) of new PDK formulations.

FIG. 10 are representative images and charts showing reduced color degradation (yellowing) when undergoing processing, as well as cut and reprocessed samples and their mechanical properties through tensile tests.

FIG. 11 are representative images and charts showing thermomechanical and rheological tunability of new PDK formulations.

FIG. 12 are sample images related to compression molding of a PDK 1.3 with mixed colors into Havana sheets.

FIG. 13 are representative images illustrating friction welding of PDKs.

FIG. 14 are representative images illustrating metal insertion into PDK material and ability to laser engrave materials.

FIG. 15 are representative images illustrating machinability of material through CNC machining.

FIG. 16 are a set of process images illustrating chemical recycling process of PDK material.

### DESCRIPTION OF THE EMBODIMENTS

The following description of the embodiments of the invention is not intended to limit the invention to these embodiments but rather to enable a person skilled in the art to make and use this invention.

### 1. Overview

A system and method a polydiketoenamine (PDK) based plastic comprises: at least one triketone, at least one polyamine, and at least one additive; wherein producing the PDK based plastic comprises either solid-state mixing of a typically liquid based polyamine and a typically solid, powder-like, triketone, or liquid-liquid implemented mixing (e.g., using reactive extrusion). The system and method function to enable a renewable plastic composition comprising monomeric compounds bound using dynamic covalent diketoenamine bonds allowing recovery of the monomeric compounds, thermal processing, and mechanical recycling. More specifically, the system functions as a renewable plastic, wherein the interaction between triketones, polyamines, and additives provides a customizable plastic material and system with desired functional and preparation properties.

The novel formulations of PDKs of the system and method may be based on certain difunctional and trifunctional polyamines and triketones discovered to demonstrate better thermomechanical performance. The approach of the system and method may polymerize these new formulations through liquid-liquid solvent methods. New formulations of the system and method enable heat stability when exposed to temperatures exceeding 250° C. Furthermore, these new formulations of PDKs may show significantly improved mechanical performance relative to previous PDK formulations and highly efficient chemical depolymerization into constituent monomers.

The ability of new PDKs of the system and method to withstand higher temperatures before decomposing may be important for processing these materials using low cost and high-throughput techniques that are common to the plastics industry. In addition, tunability of mechanical and viscoelastic properties may enable these materials to be used in applications (e.g., automotive, aerospace) where high heat stability and toughness is essential for both product/part performance and regulatory/safety concerns.

The system and method may be particularly useful for production of any general plastic compound, wherein the system and method enable the production of a renewable plastic product. More specifically, the system and method may be particularly useful for production of plastic based eye-wear. Eye-wear frame production typically includes production of plastic blocks that are then shaved down into the desired eye-wear shape. This “old” production system creates a huge amount of plastic waste, both in the production of eye-wear and the recyclability of eye-wear. The system and method may enable production of PDK plastic blocks that would enable recyclability of both the eye-wear and the plastic waste produced. The system and method enable colors and other additives to be easily extracted during recycling, create new network polymers with different additives, and repeat this process innumerably at no detriment to the recycled polymers' mechanical and aesthetic properties.

The system and method may provide a number of potential benefits. The system and method are not limited to always providing such benefits and are presented only as exemplary representations for how the system and method may be put to use. The list of benefits is not intended to be exhaustive and other benefits may additionally or alternatively exist.

Generally, the system and method provide the benefit of a potentially renewable plastic product. With the right implementation, the system and method may provide a plastic with all the desired “plastic” properties with the advantage of enabling the plastic to be recycled.

### 2. System

A system, composition, or material for a polydiketoenamine (PDK) comprises: at least one triketone, at least one polyamine, and at least one additive. The system functions as a renewable plastic composition comprising monomeric compounds (e.g., triketones and polyamines) bound using dynamic covalent diketoenamine bonds, thereby allowing recovery of the monomeric compounds. More specifically, the system functions as a renewable plastic (or plastic base), wherein the interaction between triketones, polyamines, and additives provides a customizable plastic system with desired functional and preparation properties. In some variations, the system may further include at least one reactive, or unreactive, polymer. In some variations, the system may further include at least one reactive amine.

It should be noted that beyond the presented chemical composition of its unique components, formation of the system is a non-trivial process that typically requires the combination of a liquid or solid based polyamine and a solid, commonly powder-like consistency, triketone. To note, dependent on implementation, both polyamines and triketones may be liquid, solid, or gas; herein focus will be given to a typically liquid based polyamine and a typically solid based triketone. This choice implies no limitation on the actual state of these materials. The general system composition takes into account the desired final end-product and compounds necessary to enable formation of the final end-product. For this reason, necessary compounds may, or may not, be present in the final end-product (e.g., they may be consumed during the PDK polymerization).

The system may have at least one triketone. Triketones function as one of the primary (e.g., monomer) building blocks of the PDK, wherein triketones and polyamines form diketoenamine bonds. The at least one triketone may comprise a linear or cyclic triketone. Generally, the at least one triketone may comprise any triketone that can form a diketoenamine bond with a polyamine. Examples of triketones include: cyclopropanetrione, cyanuric acid, croconic acid, nihydrine, triuret, mesoxalic acid, dioxosuccinic acid, diphenyltriketone, diphenyltetraketone, and/or triketopentane. Natural triketones include lepstospermone, isoleptospermone, flavesone, grandiflorone, myrigalone A. Synthetic triketones include nitisinone, sulcotrione, mesotione, tembotrione, and bicyclopyrone. Additionally, triketones obtained from the condensation of 1,3-diketones including acetyl acetone and derivatives, 1,3-cyclohexane dione, 5,5-dimethyl-1,3-cyclohexane dione (dimedone), barbituric acid and derivatives, beta-keto lactones and derivatives condensed with aliphatic acids, notably dicarboxylic acids such asadipic acid (TK6), suberic acid (TK8), and sebacic acid (TK10).

Triketones with heteroatoms may change rate of hydrolysis and depolymerization conditions such as time and temperature. The rate of depolymerization can be potentially beneficial for selective recovery of the monomers.

In some variations, the at least one triketone is β-triketone. In one example, the at least one triketone is TK6. In a second example, the at least one triketone is TK10. In another example, the at least one triketone comprises a TK10 and TK6 mix.

The system may have at least one polyamine. Polyamine is an organic compound having two or more amino groups. Polyamines function as one of the primary (e.g., monomer) building blocks of PDK, wherein triketones and polyamines form diketoenamine bonds. The at least one polyamine may comprise any polyamine that can form a diketoenamine bond with triketone. Examples of possible polyamines include: aliphatic and/or aromatic, linear and/or branched diamines, also polyamines such as triamine, tetraamine spermidine, spermine, putrescine, cadaverine, ornithine decarboxylase (ODC), diethylenetriamine (DETA), pentamethyldiethylenetriamine, triethylenetetramine (TETA), tetraethylenepentamine (TEPA), pentaethylenehexamine (PEHA), 1,4,7-triazacyclononane, cyclen, cyclam, tris(2-aminoethyl)amine (TREN), tris(aminomethyl)ethane (TAME). In additions, selection of monomers and reaction conditions for flexibility, strength, and stability can be commercially available polyamines (e.g., ethanamine, aminoethyl ether, linear and branched polyethylenimine, and Jeff Amines (Polyetheramines)).

In some variations, the system can stack linear polyamines to increase crystallization and Tg.

Tertiary amines typically do not react with aldehydes and ketones. Primary amines can be more reactive than secondary amines. Oxygen centered primary amines like D230 and T403 can provide more flexibility.

In some variations, the at least one polyamine may comprise an aromatic and/or aliphatic amine. In one example, the at least one polyamine is TREN (a triamine). In a second example, the at least one polyamine is DET (diamine). In another example, the at least one polyamine comprises a TREN and DET blend.

The system may include at least one additive. Additives function to provide functional properties to the system precursor compounds (e.g., improve solubility for mixing), and/or to the final system (e.g., plastic quality). In this manner, additives may be divided into “precursor additives”, that affect the precursor chemical properties of the system; and “product additives”, that affect the final end-product. It should be noted that precursor additives and product additives are a functional differentiation of additives and in no way sets a limitation on any compound classification(s), or types of compounds implemented. As this is only a functional descriptor, in many variations, the same additive may be implemented as both a type of precursor additive and a type of product additive. For example, a single compound may be incorporated as both a heat stabilizing precursor additive and as a plasticizer product additive.

As one goal of the PDK system is to provide a renewable plastic that may be broken back down into its constituents, in some variations, additives may have the limitation to not impede breakdown of the system. For this reason, some implementations may incorporate only small molecular additives which can easily be removed during the recycling process. Additionally, in some examples, additives may be used to control the rate, temperature, pressure or other controllable condition, required to achieve breakdown (depolymerization) of the PDK system.

Any general type of additive may be incorporated that will provide desired properties for either the precursor product or the end-product. Examples of additive types include: heat stabilizers, light stabilizers, plasticizers, rheology modifiers, flame retardants, and colorants. These and/or other additive types may be incorporated as desired by implementation.

In some variations, the at least one additive may include heat (and/or light) stabilizers. Heat/light stabilizers may function as a precursor additive that enables mixing of system components while preventing the PDK system from undesired breakdown or decomposition during formation and processing. For example, heated mixing may enable formation of the PDK system using reactive extrusion. Additionally or alternatively, heat/light stabilizers may enable PDK formation using other techniques. Additionally or alternatively, heat/light stabilizers may controllably improve the heat/light sensitivity of the end-product. Additionally or alternatively, heat/light stabilizers may prevent (or reduce) damage (usually through oxidation) to the polymer during precursor processing and/or for the end-product. Examples of heat/light stabilizers include: hindered organo-phosphites and hindered amines (HALS) and others.

In some variations, the at least one additive may include plasticizers. Plasticizers may function to provide the desired material properties to the final end-product. That is, plasticizers may change thermomechanical properties of the system such as: rigidity, density, glass transition temperature, melting temperature, storage modulus, loss modulus, elastic modulus, tensile modulus, hardness, gel fraction, crosslink density, luster, opacity, refractive index, tensile strength, impact resistance, thermal conductivity, electrical conductivity, etc. In some variations, plasticizers may provide a high mechanical integrity, while decreasing brittleness, enabling the end-product to be flexible, pliable, and processable. This may enable the final PDK end-product to be shaped using industry standard techniques (e.g., compression molding, CNC machining, extrusion, injection molding, etc.). The desired “plasticity” of the end-product may include blending of one, or more, non-reactive small molecules. Examples of plasticizers include: citrates (triethyl citrate, acetyl triethyl citrate, acetyl tributyl citrate), phthalates (dimethyl phthalate, diethyl phthalate, dibutyl phthalate, butyl benzyl phthalate), trimellitates (trimethyl trimellitate, triethyl trimellitate and tributyl trimellitate), esters of orthophosphoric acid (triphenyl phosphate, tricresyl phosphate, ethylhexyl diphenyl phosphate, isodecyl diphenyl phosphate), benzoates (diethylene glycol dibenzoate, dipropylene glycol dibenzoate), adipates (dimethyl adipate), tartrates, oleates, sebacates, azelates, ricinoleates, glycerol esters (glyceryl triacetate, known commercially as triacetin and glyceryl tripropionate, known commercially as tripropionin) and organo-phosphates.

Plasticizers may also be or include colorants, excess short chain monomers (e.g., excess amines that are not fully crosslinked), and/or Reactive diluents such as difunctional polyetheramine. In some variations, inclusion of colorants (such as 1% of red dye) may drastically change the Tg, YM, and elongation of the PDK.

Solvent based method for adding plasticizers may include a formulation process comprising: providing 1 g triketone (e.g., TK-6, TK-10); adding compatible solvent (e.g., DMF or DCM) to triketone; heating (e.g., heating 90° C.) and stirring or mixing to fully dissolve; then adding desired plasticizer (e.g., 0.1-25% w/w TEC) to mixture, and adding polyamine with excess amine to triketone (e.g., 0.24 mL of TREN); processing with vacuum oven (e.g., at 80 C at 20 hrs); and pressing at ˜1.1 g into desired shape.

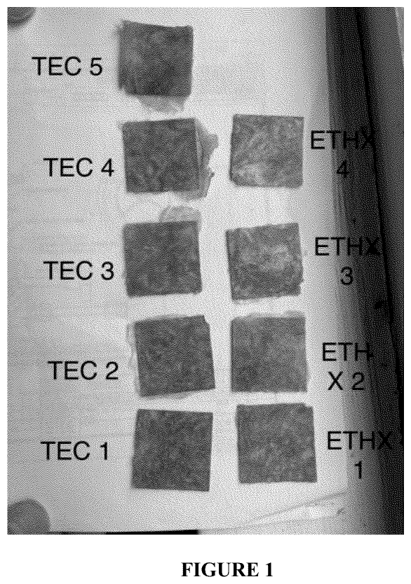

As shown in the FIG. 1, as a comparison of PDKs with increasing TEC additives (left) to PDKs with increasing ETHX additives, the PDKs may have more homogenous properties with increasing TEC than with ETHX.

In contrast to ethylhexyl sebacate (ETHX), which may have noticeable phase separation (increasing volumes of distinct opaque regions included within a yellow and transparent matrix), triethyl citrate (TEC) additive appears to be highly miscible with PDK network even up to 25% w/w to polymer. TEC series shows noticeable increase in flexibility with increased loading (as indicated by bending and folding by hand) as well as shape memory even when rolled into a tube (for 25% w/w to polymer). As an added potential benefit for a system is that TEC may be 100% bio derived.

Using the solvent/heat approach of adding plasticizers (gel, bake, press) may be able to achieve results that show Tg modulation from ˜60° C. (1% mol plasticizer to triketone) down to 0° C. (80% mol of plasticizer to triketone).

In some variations, the at least one additive may include a viscosity or rheology modifier. Rheology modifiers may function to modify/tune the processability of the precursor components. This may include: modifying the melting temperature, the “softening” temperature, and the flow of the system components to enable, and/or, improve mixing, processing and manufacturing of end-products. Rheology modifiers function primarily as precursor additives that may fix the viscosity of the system precursor compounds, and improve liquid consistency to improve system component mixing. In one example, the at least one additive includes an organic acid catalyst (e.g., para-toluene, sulfonic acid). In a second example, the at least one additive includes an organic base catalyst (e.g., triethylamine). In a third example, the at least one additive includes a Lewis acid catalyst (e.g., organo-tin, organo-zinc). The organic acid catalyst may make the precursor components more liquid for easier mixing, thus enabling processing times that make extrusion, and other manufacturing and processing techniques possible. Other rheology modifier examples include: Cellulose, calcium sulfonates, polyamides, alkali swellable emulsions (ASE), hydrophobically modified alkali swellable emulsion (HASE), hydrophobically modified ethoxylated urethane resin (HEUR), hydroxyethyl cellulose (HEC), nonionic synthetic associative thickener (NSAT).

In some variations, the at least one additive may include one or more types of flame retardants. Flame retardants may be added to slow or prevent the spread of flames. Examples of flame retardants include one or a combination of: a catalyst (e.g., ammonium salt, phosphate, polyphosphate or other), charing agent (e.g., polyhydric compounds), a blowing agent (e.g., amines, polyamines, amides, polyamides, ureas, polyureas, melamines).

In some variations, the at least one additive may include colorants. Colorants may comprise dyes and/or pigments that modify the end-product color, color density, luster, shine, and opacity/transparency, to a preferred color and/or design. In some variations, the colorants or other additives may be integrated into the end composition to enable material patterns, textures, and/or other material styling effects.

In some variations, the system may further include one or more polymers (or oligomers). These polymers may be a reactive (e.g., one or more reactive functional groups remain intact) and/or an unreactive polymer. In these variations, plasticization, heat/light stabilization, rheology modification, and or a desired combination of multiple properties of the system may be controllably achieved by blending with one or more polymers (or oligomers). Examples of these polymers (or oligomers) include: polyethers, polyesters, polyamides, polyureas, polybutadiene, polyurethanes, polyacrylates, and polymethacrylates. In variations, where the polymer (or oligomer) is reactive, the reactive functional group may form an irreversible covalent bond with the free amine functional groups in the PDK system. Examples of reactive functional groups include: isocyanate, epoxide, vinyl, alkinyl, ester, carboxylic acid, acid chloride or other.

In some variations, the system may further include one or more reactive amines. Reactive amines may comprise primary and/or secondary aliphatic and/or aromatic, linear and/or branched amines of the type: R—NH—R′, where R and R′ are optionally and independently: Hydrogen, linear or branched (C1-C20) alkyl, (C2-C20) alkenyl, alkynyl, aryl, polyether, polyester, polyamide, polybutadiene, polyurea, and/or polyurethane. The reactive amine may function to help the system achieve plasticization, heat/light stabilization, rheology modification, and or a desired combination of multiple properties of the system may be controllably achieved. When blended with the PDK polymer system these amines may react with free triketone monomers, or bond exchange with the PDK network in order to form a covalent bond to the polymer.

As described above, the system may have many implementations. In one example of the PDK system, the at least one polyamine comprises TREN. In one implementation of this example, the at least one additive comprises p-toluenesulfonic acid of up to 20 mol % relative to triketone.

In another example of the PDK system, the at least one triketone, the at least one polyamine at 0%-10% amine excess relative to available triketone functional group. The at least one additive comprises triethyl citrate of up to 80 mol % relative to the at least one triketone. The monomers and additives may be combined through ball milling, high-shear mixing, or mixing in the presence of one or more solvent at room temperature or optionally at elevated temperatures. The polymer is pressed into plastic sheets at elevated temperature and pressure.

In another example of the PDK system, the at least one polyamine comprises TREN and DET, wherein TREN comprises the majority concentration (by weight). In one example, the at least one additive comprises triethyl citrate up to 80 mol % to triketone. Optionally, other additives may be included, such as: a heat stabilizer, a rheology modifier and a colorant.

In another example of the PDK system, the at least one triketone comprises TK10 and TK6, wherein the TK10 provides the majority concentration (by weight), the at least one polyamine comprises TREN and DET, wherein TREN comprises the majority concentration (by weight). The at least one additive may be completely implementation dependent (e.g., any set of heat stabilizers, rheology modifiers, colorants, and/or plasticizers).

### 3. Method

Formation of a PDK based plastic is a complex process requiring formation of a PDK resin by polymerization of a polydiketoenamine bond through the combination of polyamine and triketone monomers, and plasticization of the PDK resin. Formation of the PDK resin may be particularly tricky due to polyamines being typically available as a liquid, and triketones available typically as a solid.

Mixing/preparation methods for a formulation based on the states of the initial components will be presented. As mentioned above, typically polyamines are available as liquids and triketones are available typically as solids; but both these compounds may be generally found and/or acquired in a state (e.g., liquid, gas, solid powder or gel). For formulations that require a different state of the starting material, it is assumed that the starting material is initially converted into the appropriate state using standard available techniques. For example, for liquid-liquid mixing formulation, a triketone powder may be initially melted prior to mixing.

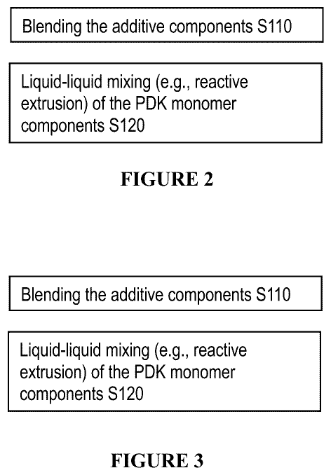

As shown in FIG. 2, a first method for PDK based plastic formation comprises: blending the additive components S110 with one, or both, monomer components; and liquid-liquid mixing of the PDK monomer components S120. This method may be particularly useful for implementations that incorporate small molecule additives. Additionally, this method may result in a high degree of mixing of additive components as compared to other methods, such that a homogeneous mixture of polymer and additive can be controllably achieved.

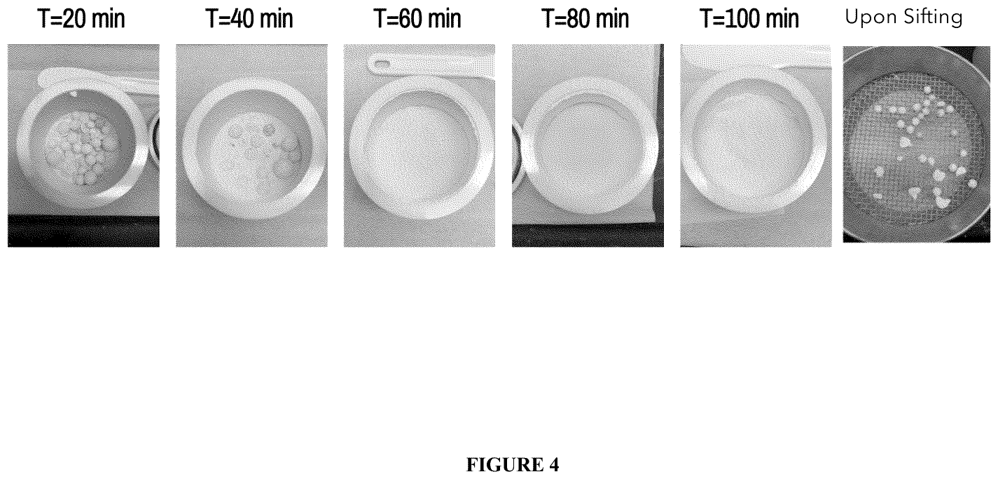

In one variation, the method may include promoting PDK polymerization through ball milling. As shown in FIG. 4, PDK polymerization through ball milling may vary by time and rate. With certain formulations, ball milling may lead to sticky paste like polymer which was difficult to dry and use for further material production.

In the exemplary process photos of FIG. 4, the following observations have been made. At T=20 min: The powder is still white, looking like TK10 monomer powder.

T=40 min. Finer powder with much bigger soft clumps (˜15 mm dial.). Clumps are unreacted monomers.

At T=60 min: Very fine powders with soft small clumps. In general, reagents did not stick to the sides of the jar.

At T=80 min: Bigger soft clumps reformed again from smaller clumps.

At T=100 min: Some small soft clumps were buried deep in fine powders.

T=120 min to T=180 min: No noticeable change in powder consistency and texture. Some clumps still present.

Milling it all the way to T=260 min did not cause any significant change. The clumps were re-ball milled separately.

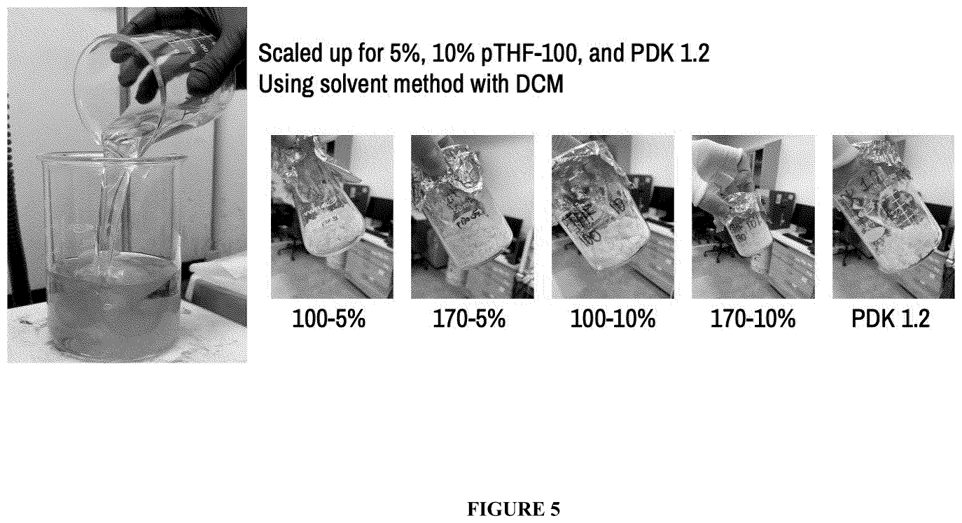

In another variation, PDK polymerization may be facilitated through a solvent method. The solvent method may include adding polyamines (e.g., triamine) into a mixture of reacted triketone (e.g., TK6, 10) with chain extender (e.g., diamine) as shown in the first image of sample photos shown in FIG. 5.

### Solvent Method

With plasticizers e.g., pTHF100_5%: 10 g TK10; adding equivalent DCM at elevated temperature to dissolve; then add additional DCM at RT. Then dissolve 5 mol % pTHF100 in 1.3 ml of DCM. Add to TK10 solution under stirring at RT for 5 min. Then crosslink with 2.28 g of TREN (neat) at RT, then heat at 125 C until stirring stops and gel forms. Weigh material and put sample under vacuum for 12 hours at 110 C.
PDK variation 2 formulation: Repeat above method using heat resistant polyamines (triamines).
PDK variation 3 formulation:
1. Triketone monomers (e.g., TK10) are melted and dissolved in solvent (e.g., DCM)
2. Color or dye is added in similar solvent
3. Add chain extenders (e.g., diamines) into TK mixtures, let react for 5 min at elevated temperature.
4. Once mixed, add crosslinker (e.g., triamines) and reactants will polymerize
5. Start boiling off the DCM with polymerization, then leave polymer in vacuum for 24 hours at ˜110 C to let water evaporate.

Block S110, which includes blending the additive components, comprises blending additives with one, or both, monomer components (e.g., blending additives with polyamines and/or triketones). Blending the additive components functions to achieve a high degree of mixing in the resulting polymer additive blend. Specifically, some additives will blend better with triketones, and others will blend better with polyamines. Thus, dependent on block S110 blending with either, or both, monomers are dependent on the additives included in the implementation. In one example, additives may comprise approximately 1%-50%, by weight, of the PDK based plastic. Preferably, blending the additive components S110 achieves a high degree of mixing (e.g., 20%-50% by weight) in the polymer.

In some variations, blending the additive components S110 may additionally, or alternatively, include blending additive components with the already formed PDK resin. Dependent on the included additives, some additives may blend better after formation of the PDK resin (e.g., a gaseous or liquid-based additive that diffuses through the already formed resin).

Dependent on the reagent implementation, plasticization may not be fully achieved. The first method may thus further include blending a polymer (or oligomer) with the PDK resin solution. The incorporated polymer(s) (or oligomer(s)) may comprise reactive and/or unreactive polymers. Examples of possible polymers include: oligomers or polymers consisting of polyethers, polyesters, polyureas, polyamines, polybutadiene, polyurethanes, polyacrylate, polymethacrylate. In variations, where the blended polymer(s) are reactive oligomers or polymers, the reactive functional group (e.g., isocyanate, nitrile, epoxy, vinyl, ester, amide, alkynyl, alkenyl) may be able to form an irreversible covalent bond with the free amines in the PDK polymer. When fully reacted, the PDK polymer solution may have excess amine present. This excess amine may react with any one of the blended polymers to specifically control for desirable properties. In some examples the PDK polymer solution may be blended with a minority component of reactive oligomer/polymer (1%-50% by weight). In other examples, PDK polymer solution may be blended with a majority component (50%-90% by weight).

Dependent on the reagent implementation, plasticization may not be fully achieved. The first method may thus further include blending one, or more, reactive amines. Through the addition of one or more reactive primary and/or secondary amines of the type R—NHR′; where R and R′ are optionally and independently Hydrogen, (C1-C20) alkyl, (C2-20) alkenyl; (C2-20) alkynyl, aryl, or polyether; polyester, polyamines, polybutadiene, polyurea, polyurethane. When blended with PDK polymer solution, these amines may react with available triketone monomers, or bond exchange with the PDK network in order to form a covalent bond to the polymer.

Block S120 which includes liquid-liquid mixing of the PDK monomer components, functions to form the PDK resin, e.g., the primary building of the PDK based plastic. As triketones are typically in solid form, liquid-liquid mixing may require the addition of additives and thermodynamic conditions to enable, or promote, liquid-liquid mixing. Dependent on implementation, any type of liquid-liquid mixing method may be implemented. Examples of liquid-liquid mixing methods that may be implemented include: using a THINKY mixer, using a high vacuum mixer, using a heated solvent, and using reactive extrusion.

In one variation, liquid-liquid mixing of the PDK monomer components S120 comprises using reactive extrusion for mixing. Using reactive extrusion mixing may comprise mixing in reactive extrusion additives. In one example, an organic acid catalyst (such as para-toluene sulfonic acid) is mixed in as a reactive extrusion additive; wherein para-toluene sulfonic acid may make the mixture, “more liquid” (viscosity or rheology modifier) to improve reactive extrusion conditions. One example of other reaction extrusion additives may include heat stabilizers (e.g., organophosphites) to protect the system from thermal damage that may occur during the reactive extrusion conditions. Another example of extrusion additives includes plasticizers (e.g., triethyl citrate) in order to control the optimal temperature required for reactive extrusion of the system.

As shown in FIG. 2, a second method for PDK based plastic formation comprises: blending the additive components S210 with one, or both, monomer components; and solid-state mixing of the PDK monomer components S220. This method may be particularly useful for implementations that the incorporation of small additives. In some variations, the method may further include adding one, or more solvents, to mediate the mixing.

Block S210, which includes blending the additive components, comprises blending additives with one, or both, monomer components (e.g., blending additives with polyamines and/or triketones). Blending the additive components functions to achieve a high degree of mixing in the resulting polymer additive blend. Specifically, some additives will blend better with triketones, and others will blend better with polyamines. Thus, dependent on block S210 includes blending with either, or both, monomers is dependent on the additives included in the implementation. In one example, blending the additive components S210, may include blending one, or more, small molecule plasticizer (e.g., citrates, sebacates, adipates, phosphates, and others) first with one, or more monomers (e.g., just triketone, just amine, or both triketone and amine). This blending may be necessary in order to achieve both high loading (e.g., 20%-50%, by weight) and high degree of mixing (homogeneously distributed throughout the polymer) in the resulting polymer plus additive blend whereas phase separation in the mixing step can occur with non compatible additives or too much loading.

Analogous to liquid-liquid mixing, in some variations, blending the additive components S210 may additionally, or alternatively, include blending additive components with the already formed PDK resin. Dependent on the include additives, some additives may blend better after formation of the PDK resin (e.g., a gaseous or liquid based additive that diffuses through the already formed resin).

Block S220, which includes solid-state mixing of the PDK monomer components, functions to mix a solid (e.g., powder-like) triketone monomer, with liquid poly-amine. Solid-state mixing of the PDK monomer components S220 may comprise mechanical mixing of the components to enable and achieve polymerization. In one variation of solid-state mixing, mechanical mixing is implemented until a ball mill is formed.

A detailed exemplary process for PDK Synthesis using Ball Mill may be as follows:
a. Providing TK10 amount. In one example, TK10 (10 g) is weighed out and placed in the bottom of a 250 mL zirconia grinding jar
b. Adding TREN to TK10. In the example, TREN (2.4 mL=2.4 g) is pipetted (or otherwise added) directly into the TK10
c. Adding milling balls. In the example, 20 large (˜1 cm) zirconia balls can be placed on top of the TK10/TREN solid/liquid mixture
d. Ball milling mixture. In the example, the mixture was ball milled for 60 min in 20 min increments
   i. A sticky yellow goo forms (likely PDK oligomers) and sticks to the bottom of the container. It is important to scrape this sticky material away from the bottom/sides of the jar in order to ensure proper mixing
e. Drying powder under vacuum. In the example, a white powder was dried under vacuum for 48 h to remove all water=Dry PDK

An example of sample pressing may be as follows:
a. Adding PDK to block mold. In the example, Dry PDK is weighed out and placed into a 4 mm deep (30×30 mm) aluminum block mold
   i. The mold is filled with PDK and then briefly heated above Tg to make the powder sticky. The sticky powder is easier to press into the corners of the mold and allows for packing of the total amount of material.
b. Pressing sample. In an example, the sample is pressed (5-30 k psi) above Tg for 5 min.
   i. Surface defects were smoothed out by pressing the sample an additional 2 min in one minute increments at 25 k psi.

Dependent on the reagent implementation, plasticization may not be fully achieved. The second method may thus further include blending a polymer (or oligomer) with the PDK resin solution. The incorporated polymer(s) (or oligomer(s)) may comprise reactive and/or unreactive polymers. Examples of possible polymers includes: oligomers or polymers consisting of polyethers, polyesters, polyureas, polybutadiene, polyurethanes, polyacrylate, polymethacrylate. In variations, where the blended polymer(s) are reactive oligomers or polymers, the reactive functional group (e.g., isocyanate, epoxy, vinyl) may be able to form an irreversible covalent bond with the free amines in the PDK polymer. When fully reacted, the PDK polymer solution may have excess amine present. This excess amine may react with any one of the blended polymers to specifically control for desirable properties. In some examples the PDK polymer solution may be blended with a minority component of reactive oligomer/polymer (1%-50% by weight). In other examples, PDK polymer solution may be blended with a majority component (50%-90% by weight).

Dependent on the reagent implementation, plasticization may not be fully achieved. The second method may thus further include blending one, or more, reactive amines. Through the addition of one or more reactive primary and/or secondary amines of the type R—NHR′; where R and R′ are optionally and independently Hydrogen, (C1-C20) alkyl, (C2-20) alkenyl; (C2-20) alkynyl, aryl, or polyether; polyester, polyurea, polyamide, polybutadiene, polyurethane. When blended with PDK polymer solution, these amines may react with available triketone monomers, or bond exchange with the PDK network in order to form a covalent bond to the polymer.

Diamines e.g., D230 or DET will act as chain extenders to the triamine cross linkers e.g., T403, TREN. Chain extenders in PDK network has shown to increase elongation to break and can be crucial to increase overall toughness of the network. Excess amine functional groups in the di and triamines may contribute to dynamic amine exchange rates, processing e.g., Pressing, manufacturing, extrusion conditions like temperature and pressure

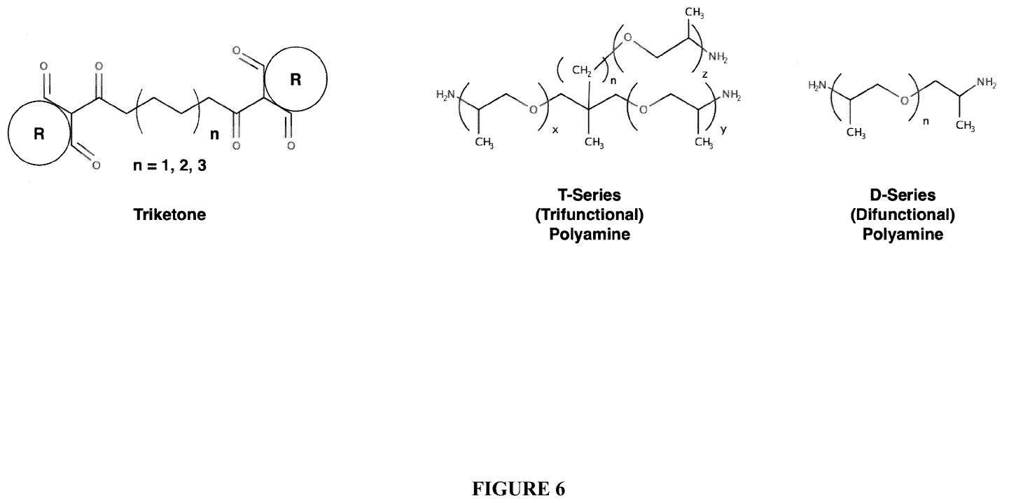

A cross-linked network with extended chains such as trifunctional cross-linker with polyetherdiamines serving as chain extenders would afford a tough PDK material. The presence of phenyl groups generally increases the Tg of a polymer but at the cost of making it brittle. Inclusion of an aromatic polyamine (e.g., Triphenylene-1,5,9-triamine) can create a rigid cross-linking site which, in molar equivalents to triketone, would create a high Tg, strong but brittle material. To make this material tough, we can include flexible polyether chains, increasing polymer mobility and free volume (e.g., PolyTHF polyetherdiamine). The presence of a rigid, planar Representations for triketone, T-Series Polyamine, and D-Series, polyamine are shown in FIG. 6.

Polyamine formulation (various functionality, di and tri series, and molecular weight) can increase toughness and elongation to break, create tunable Tg, tunable rheology, and increase thermal stability:

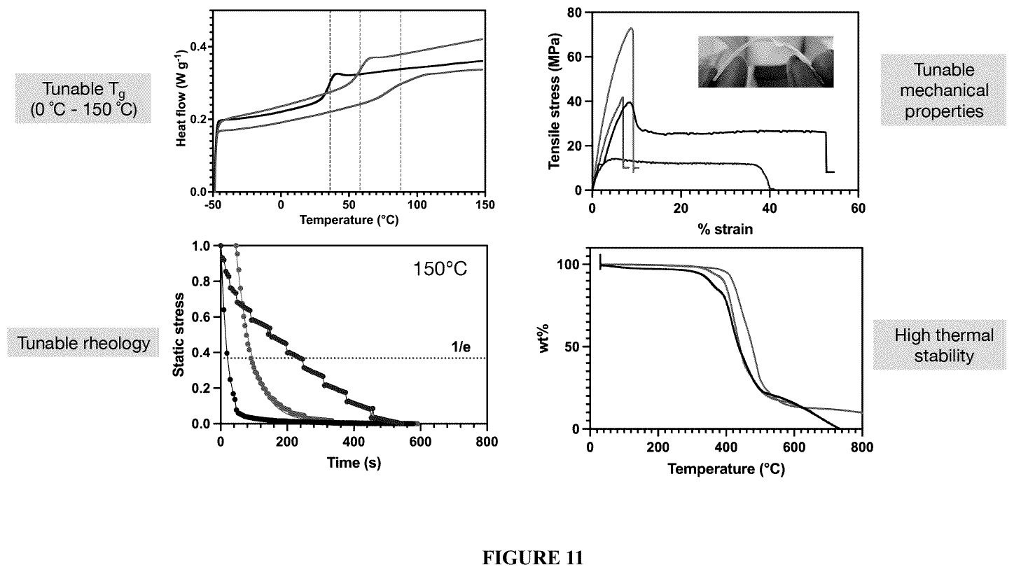

As shown in FIG. 11, the material may have various beneficial properties related to tunable T_{g}, tunable mechanical properties, tunable rheology, and high thermal stability. FIG. 11 shows various mechanical properties and PDK 1 with PTHF170, 1% in photo top right.

Polydiketoenamines (PDKs) are a class of dynamic covalent polymers that enable thermal processing and reprocessing of networked, or cross-linked polymers in the system. While PDKs have been shown to be thermally processable, many formulations of PDKs begin to decompose when processed or used at temperatures >200° C. In order to process PDKs and PDK blended formulations, it is beneficial that the polymer have a significantly higher decomposition temperature that the temperatures required to process the material into functional parts and products. Specific Advance: Most prior versions of PDKs begin to degrade or decompose at temperatures below 200° C. Formulations of PDKs that can be exposed to temperatures >200° C., and ideally >250° C., enable the materials to be used in applications (e.g., automotive, aerospace) where high heat stability is essential for both product/part performance and regulatory/safety concerns.

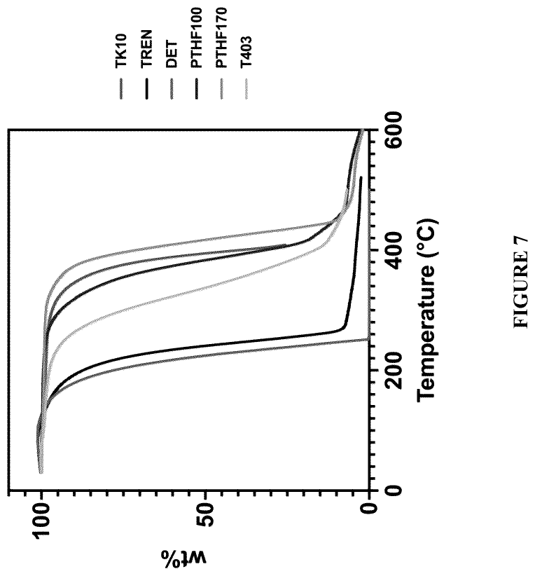

FIG. 7 shows TGA of various monomers show T403 with higher thermal stability than TREN or DET.

The system leverages discovery of certain formulations of PDKs (PDK1.2) based on certain difunctional and trifunctional polyamines and triketones that enable heat stability when exposed to temperatures exceeding 250° C. The ability of PDK1.2 to withstand higher temperatures before decomposing is critical for processing these materials using low cost and high-throughput techniques that are common to the plastics industry. One such technique is twin-screw extrusion, which is commonly employed to blend polymer resins with myriad additive systems (e.g., colors, glass-fibers, carbon fibers). PDK 1 formulations decompose when exposed to temperatures high enough (>200° C.) required for extrusion. Owing to their high thermal stability, PDK1.2 formulations can access temperatures high enough to enable extrusion.

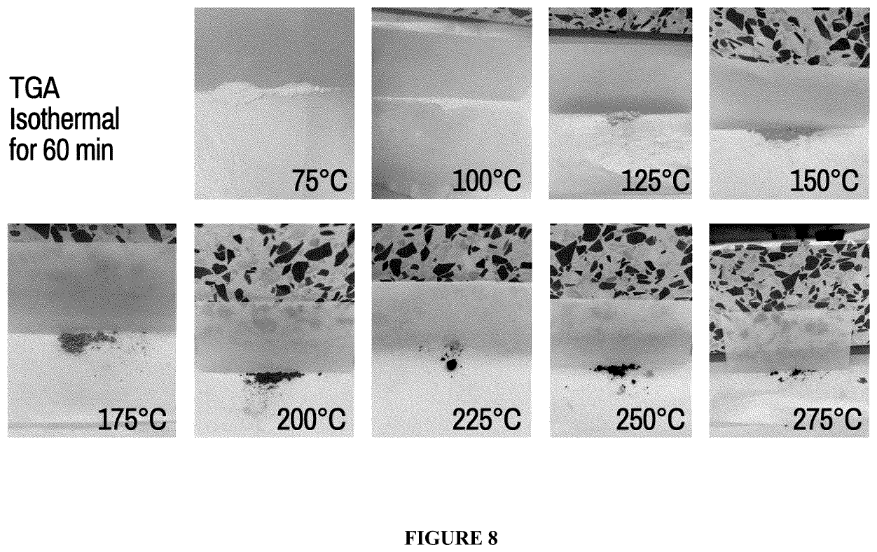

As shown in FIG. 8, some PDK formulations begin to yellow when exposed to temperatures above 100° C. and decompose and turn black when exposed to temperatures above 200° C.

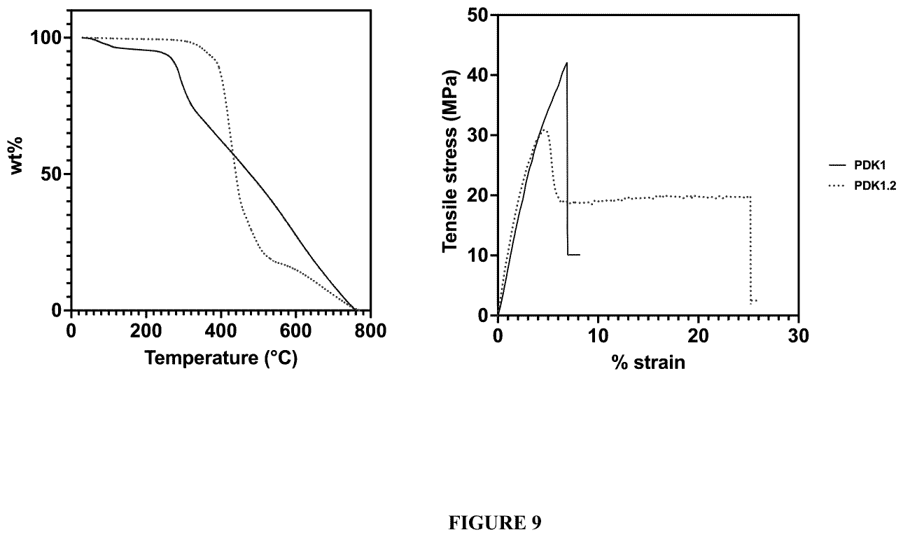

As shown in the first chart of FIG. 9, Thermogravimetric analysis (TGA, measures mass loss as a function of time and temperature) of old PDKs (PDK1, solid line) vs new PDKs (PDK1.2, dotted line) show improved thermal stability when exposed to temperatures >200° C. PDK1.2 shows behavior of a polymer that yields (instead of going straight down, the material elongates or stretches out before breaking). The elongation (Strain %) for PDK1.2 improved by more than 100% compared to PDK1.

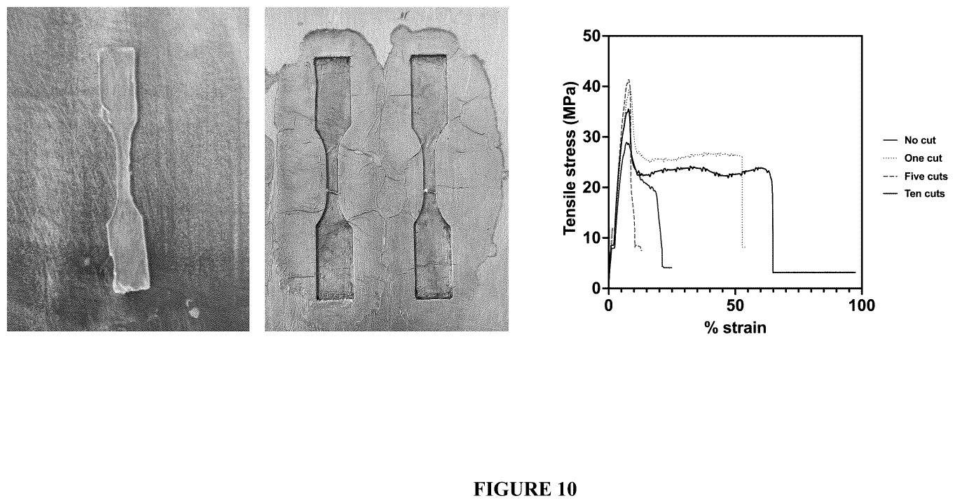

As shown in FIG. 10, a sample of new PDK shows only minimal yellowing when processed in a compression mold at 250° C., 20,000 psi, for 5 min (left). PDK 1.2 can also be repressed under heat and pressure to observe similar or better mechanical properties (middle, right).

The Right chart of FIG. 9 shows representative tensile properties of old PDKs (PDK1, solid line) vs. new PDKs (PDK1.2). PDK1 shows typical behavior of a brittle polymer (fracture), while PDK1.2 shows behavior of a polymer that yields (instead of going straight down, the material elongates showing necking before fracture). The elongation (Strain %) for PDK1.2 improved by more than 100% compared to PDK1.

Variations of the PDK1.2 formulations may also enable extrudable materials.

As used herein, first, second, third, etc. are used to characterize and distinguish various elements, components, regions, layers and/or sections. These elements, components, regions, layers and/or sections should not be limited by these terms. Use of numerical terms may be used to distinguish one element, component, region, layer and/or section from another element, component, region, layer and/or section. Use of such numerical terms does not imply a sequence or order unless clearly indicated by the context. Such numerical references may be used interchangeable without departing from the teaching of the embodiments and variations herein.

As a person skilled in the art will recognize from the previous detailed description and from the figures and claims, modifications and changes can be made to the embodiments of the invention without departing from the scope of this invention as defined in the following claims.

Manufacturing of cellulose acetate eyewear frames require plastic to have certain characteristics such as the following:
1. High toughness for CNC machining
   a. High young's modulus (1 GPa)
   b. High elongation to break (35%)
2. High Tg (glass transition temperature)
   c. 30 C-115 C
3. Fast stress relaxation (tens of seconds at processing temp of 150 C)

### Eyewear Manufacturing

Additives such as modifiers, plasticizers, colorants, stabilizer: Literature has reported (Ghiya & Dave, Fridman et al, Wibowo et al) use of plasticizer in cellulose acetate in a range between 5-50% however, with cross-linked polymers using too much could lead to phase segregation.

The modifications made to original PDK formulation can achieve desirable properties for the eyewear manufacturing. PDK 1.2 can achieve high modulus and extremely fast stress relaxation, PDK 1.3 can achieve elongation to break of up to 100%. Both PDK variations can be machined and within the required Tg window.

The processes of producing these sheets outlined in the Mazzucchelli block process include mixing together a polymer, plasticizer, and potential solvents, running them through a calendaring process to homogenize the desired color. Then reducing them into raw sheets superimposed by presses using heat and pressure. The extrusion process can obtain sheets from colored granules by melting said polymer mixture granules and passing them through a dye to yield sheets of your desired material. The compression process uses semi-finished products from the previous two processes and brings them into a mold that yields a sheet without the use of solvent. Lamination is another process, but this uses a polymer sheet form the previous processes and laminates a thin block layer on top of it for some special types of frames.

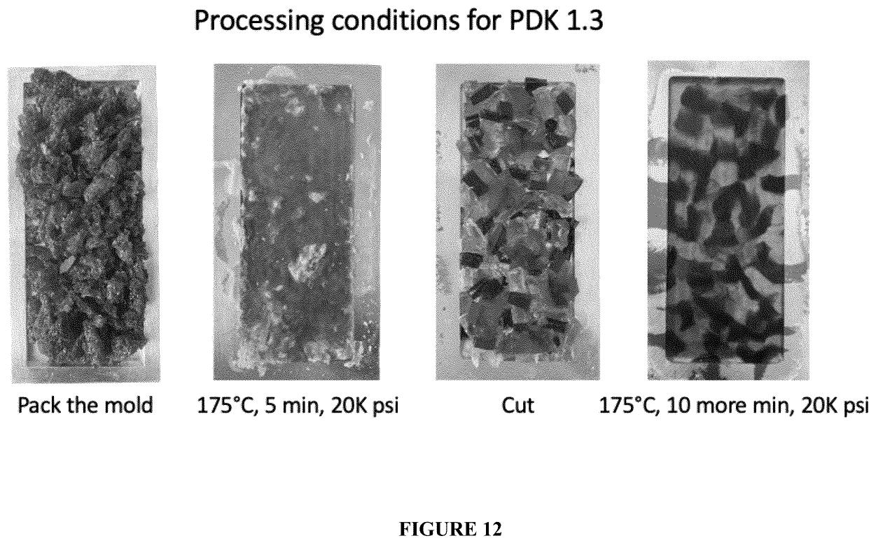

For the system and method, we compression mold the pellets of PDK1,2,3 using carver press. Material can experience shrinking and warping, common to cellulose acetate. As shown in FIG. 12, PDK 1.3 may be compressed molded with mixed colors into Havana sheets.

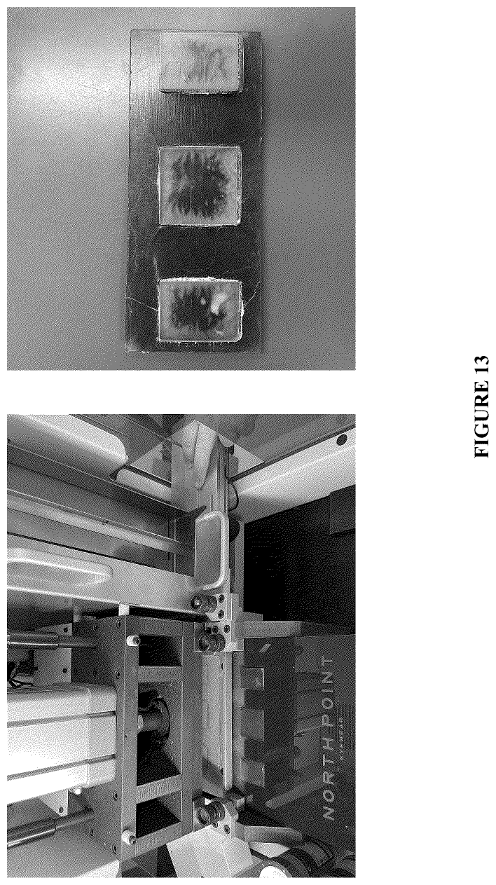

We have demonstrated friction welding is possible for PDKs, as shown in friction welding photos shown in FIG. 13, while it is typically not possible for thermoset plastics. Friction welding creates heat which activates dynamic amine exchange.

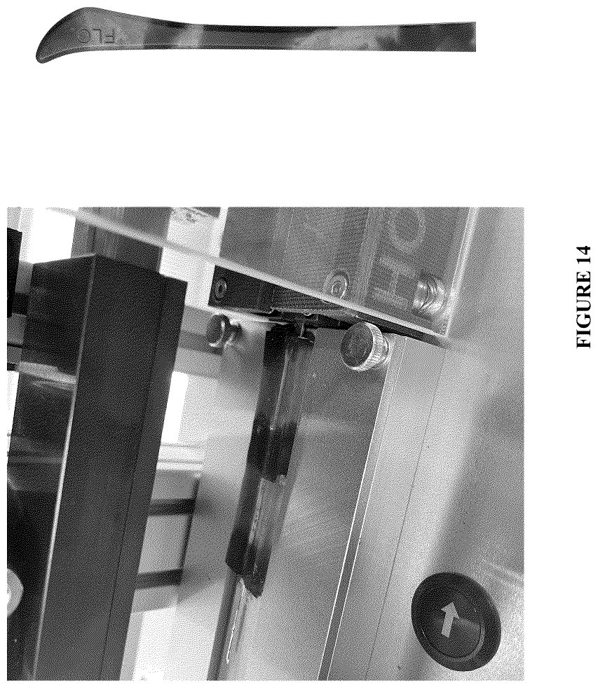

We have demonstrated that metal wire can be inserted into PDK materials at processing temperature of acetate as shown by the example image of PDK 1.3 being processed as such in FIG. 14. Accordingly, the PDK formulations of the system and method such as PDK 1.3 may be laser engraved or processed.

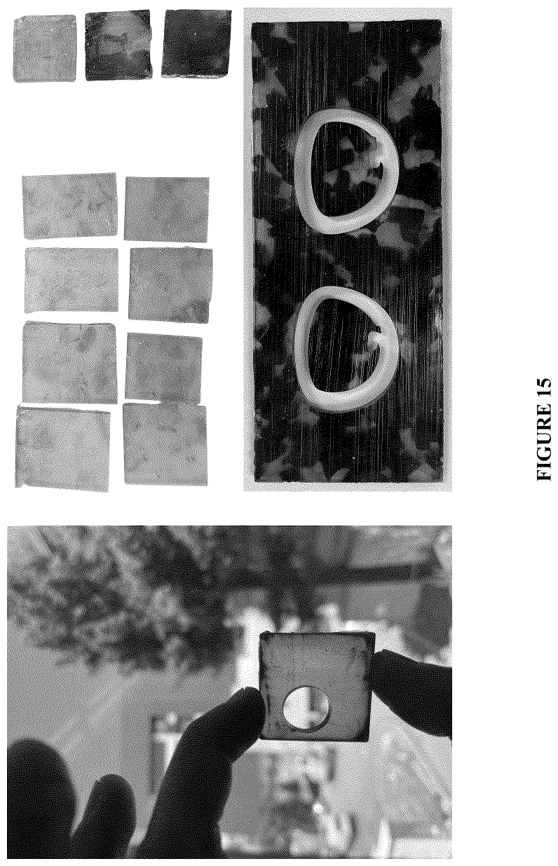

Additionally, we have demonstrated CNC machining in various PDKs of the system and method. As shown in FIG. 15, the PDK may be machined using a CNC. In the left-most photo of FIG. 15, PDK was machined using a Bantam CNC mill (¼ in flat end drill tip). A circle of 2 mm diameter was milled into a 4 mm PDK-1 sheet. (right) PDK 1.3 Feed rate 1500 mm/min. Spindle speed 20,000 rpm. End-mill ˜⅛″ (3-4 mm) in diam. These parameters help to cut material smoothly without overheating it. This may enable other mill-based manufacturing processing of the resulting material.

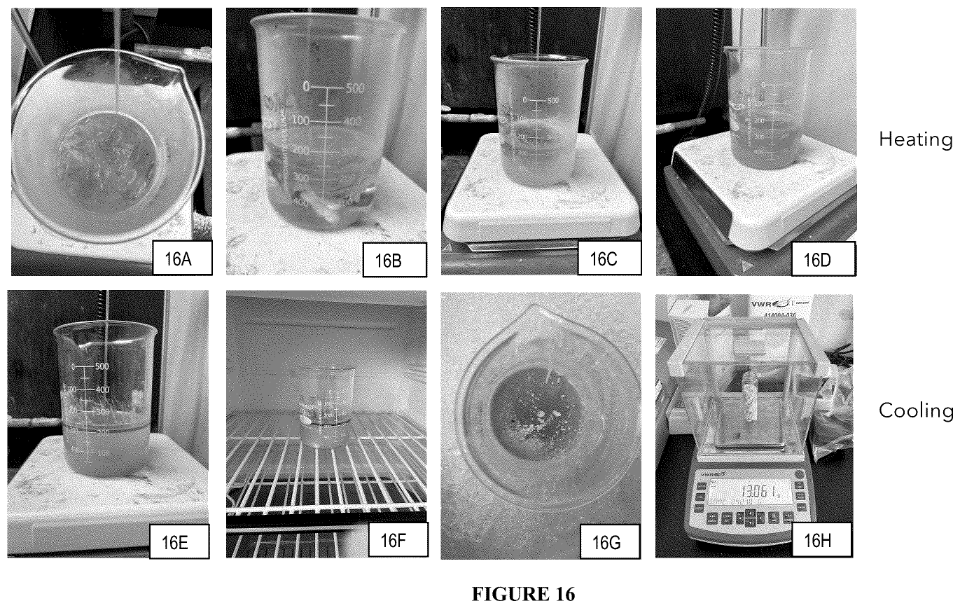

As shown in FIG. 16, PDK Recycling in mixed waste stream (PDK1.3) may be possible. Description herein demonstrate triketones can be chemically recycled in diamine and triamine mixtures and color additives. A description of the process is as follows:
Materials: 3.0 g of PDK1.3 (5% D230, T403, TK10)
Conditions: 6M H2SO4 (2 mL H2SO4 in 4 mL DI H2O), heated to ˜100° C., ambient pressure, with stirring.
1. (16A, 16B, 16C) All PDK waste added to H2SO4 while temperature ramping up
2. (16D, 16E) After 20 min, cloudy and orange with big pieces falling out
3. After 30 min, All solid PDK samples have completely disappeared, and a biphasic liquid mixture has formed.
4. Yellow water phase with off-white solid remaining on top.
5. Biphasic mixture with oily liquid floating on top of the acid and water.
6. After 25 min in the fridge (16F), no solids have formed. Beaker was transferred to an ice bath to facilitate cooling.
7. (16G) After ˜15 min in ice bath, a small amount of the now thick, syrupy oil phase was removed. This sample immediately hardened to form a white crystalline solid. This solid was scraped back into the oil phase in an attempt to seed further crystallization.
8. After ˜1 hr cooling in ice bath the thick syrupy oil phase had (mostly) solidified to form an off-white semi-crystalline solid. Some areas remained semi-sold (much like crystallized honey) but were robust enough to be scraped away from the aqueous phase below. Solid was vacuum filtered using a Büchner funnel and washed with copious amounts of water. The now almost completely solid off-white material was collected and placed in a vial. NMR identified as Triketone. Crude (wet) yield of recovered solids is 13.06 g (91%) (16H).

The systems, methods, and compositions and their variations described herein may be combined in various forms. Following are varying descriptions of preferred embodiments and variations.

In one exemplary embodiment (var1.1), the heat resistant plastic material comprises a triketone, a heat resistant difunctional or trifunctional polyamine that forms dynamic covalent bonds with the triketone, and a plasticizer. This exemplary embodiment may include different variations. Some exemplary variations are outlined below.

In one exemplary variation (var1.2), the triketone of the heat resistant plastic material may include one or more of the following: TK6, TK8, TK10, and a triketone with one or more heteroatoms.

In another exemplary variation (var1.3), the polyamine is T403. In another variation, the polyamine is DET.

In another exemplary variation (var1.4), the plasticizer is one or more of a colorant, a short chain monomer, a reactive amine, and a reactive diluent such as polyetherdiamine.

In another exemplary variation (var1.5), the triketone has available functional groups, and wherein the heat resistant difunctional or trifunctional polyamine has between about 0%-10% excess amine relative to available triketone functional groups.

In another exemplary variation (var1.6) of var1.5, the excess amine acts as a plasticizer.

Another exemplary variation (var1.7) of var1.5 may further comprise a reactive oligomer or polymer with one or more functional groups that form covalent bonds with the excess amine.

In another exemplary variation (var1.8) of var1.7, the reactive oligomer or polymer acts as a plasticizer.

In another exemplary variation (var1.9) of var1.7, the reactive oligomer or polymer acts as a rheology modifier.

In another exemplary variation (var1.10) of var1.7, the reactive polymer or oligomer comprises one or more of polyether, polyester, polyurea, polyamides, polybutadiene, polyurethane, polyacrylate, and polymethacrylate.

In another exemplary variation (var1.11), the triketone has available functional groups, and wherein the heat resistant difunctional or trifunctional polyamine has excess amine (relative to available triketone functional groups) in a proportion less than that which would result in oversaturation of polyamines.

In another exemplary variation (var1.12), the plastic material may further comprise one or more reactive amines.

In another exemplary variation (var1.13) of var1.12, one or more reactive amines are amines of the type R—NHR′, where R and R′ are optionally and independently hydrogen, (C1-C20) alkyl, (C2-20) alkenyl; (C2-20) alkynyl, aryl, or polyether; polyester, polyurea, polyamides, polybutadiene, and polyurethane.

In another exemplary variation (var1.14) of var 1.12, the one or more reactive amines react with available triketone functional groups.

In another exemplary variation (var1.15) of var 1.12, the heat resistant plastic is in the form of a polydiketoenamine (PDK) network.

In another exemplary variation (var1.16) of var 1.16 the one or more reactive amines bond exchange with the PDK network.

In a second exemplary embodiment (var2.1) related to the method of making PDK1.2, a method for making a heat resistant polydiketoenamine (PDK) plastic material comprising the following steps: providing a triketone in liquid form; and combining the liquid triketone with a heat resistant difunctional or trifunctional polyamine to form a PDK resin.

In one exemplary variation (var2.2), the method further comprises adding a plasticizer to the PDK resin.

In one exemplary variation (var2.3), the triketone is one or more of TK6, TK8, TK10, and a triketone with one or more heteroatoms.

In one exemplary variation (var2.4), the polyamine is T403.

In one exemplary variation (var2.5), the polyamine is DET.

In one exemplary variation (var2.6), possibly of var2.2 or any other exemplary variation the plasticizer is 5 mol % poly(tetrahydrofuran)bis(2-aminopropyl ether) (pTHF).

In one exemplary variation (var2.7), the liquid triketone and the heat resistant difunctional or trifunctional polyamine are combined to form a PDK resin via reactive extrusion.

In one exemplary variation (var2.8) of var2.7, the method further comprises adding one or more reactive extrusion additives.

In one exemplary variation (var2.9) of var2.8, the one or more reactive extrusion additives includes a catalyst.

In one exemplary variation (var2.10) of var2.9, the catalyst comprises an organic acid such as para-toluene sulfonic acid.

In one exemplary variation (var2.11), of var.2.10, the plastic material has a stress relaxation characteristic that depends on the proportion of included reactive catalyst.

In one exemplary variation (var2.11) of var2.8, the one or more reactive extrusion additives includes a rheology modifier.

In one exemplary variation (var2.12) of var2.11, the rheology modifier comprises one or more of para-toluene sulfonic acid, cellulose, calcium sulfonates, polyamides, alkali swellable emulsions (ASE), hydrophobically modified alkali swellable emulsion (HASE), hydrophobically modified ethoxylated urethane resin (HEUR), hydroxyethyl cellulose (HEC), and nonionic synthetic associative thickener (NSAT).

In one exemplary variation (var2.13) of var 2.8, the one or more reactive extrusion additives includes a heat stabilizer.

In one exemplary variation (var2.14) of var 2.13, the heat stabilizer is an organophosphite.

In one exemplary variation (var2.15) of var2.8 or other exemplary variations, the one or more reactive extrusion additives includes a plasticizer.

In one exemplary variation (var2.16) of var 2.15, the plasticizer is triethyl citrate. In one exemplary variation (var2.17), the method further comprises heating the

triketone to provide it in liquid form.

In one exemplary variation (var2.18), the method further comprises adding a solvent to the triketone to provide it in liquid form.

As an alternative method variation (var 2.19), a method for making a heat resistant PDK plastic material comprises: providing a triketone; adding a solvent to the triketone; heating the triketone and the solvent so that the combination becomes liquid, creating a first mixture; adding one or more plasticizers, colorants, or both to the first mixture, creating a second mixture; adding a difunctional or trifunctional polyamine to the second mixture, creating a third mixture, wherein the third mixture includes residual solvent and water; heating the third mixture to remove the residual solvent and form a polymer; and applying a vacuum to the polymer to remove the residual water.

In another exemplary variation (var2.20) of var2.19, the difunctional or trifunctional polyamine forms dynamic covalent bonds with the triketone.

In a third exemplary embodiment (var3.1) related to PDK1.3 material, a heat resistant plastic material, comprises: a triketone; a diamine that acts as a chain extender; a triamine that acts as a cross-linking agent; and a plasticizer.

In one exemplary variation (var3.2), the triketone comprises one or more of TK6, TK8, TK10, and a triketone with one or more heteroatoms.

In another exemplary variation (var3.3), the triamine is an oxygen-centered primary triamine.

In another exemplary variation (var3.4) of var3.3, the oxygen-centered primary amine is T403.

In another exemplary variation (var3.5), the diamine comprises one or more of D230, DET, and polyether diamines.

In another exemplary variation (var3.6), the triketone has available functional groups, and wherein the diamine, the triamine, or both are present in sufficient proportions such that there are between about 0%-10% excess amine relative to the available triketone functional groups.

In another exemplary variation (var3.7) of var3.6, the excess amine acts as a plasticizer.

In another exemplary variation (var3.8) of var3.6, the plastic material has a stress relaxation characteristic that depends on the proportion of excess amine.

In another exemplary variation (var3.9) of var3.6, the plastic material may further comprise a reactive oligomer or polymer with one or more functional groups that form covalent bonds with the excess amine.

In another exemplary variation (var3.10) of var 3.9, the reactive oligomer or polymer acts as a plasticizer.

In another exemplary variation (var3.11) of var3.9, the reactive oligomer or polymer acts as a rheology modifier.

In another exemplary variation (var3.12), the triketone has available functional groups, and wherein the diamine and triamine have excess amine (relative to available triketone functional groups) in a proportion less than that which would result in oversaturation of polyamines.

In another exemplary variation (var3.13), the plasticizer is 5 mol % poly(tetrahydrofuran)bis(2-aminopropyl ether) (pTHF).

In another exemplary variation (var3.14), the plastic material has a toughness value that increases with increasing molecular weight of the pTHF.

In another exemplary variation (var3.15), the plastic material has a toughness value that increases with increasing molecular weight of the diamine, the triamine, or both.

In another exemplary variation (var3.16), the plastic material has a glass transition temperature (Tg) that depends on the ratio of diamine to triamine.

In another exemplary variation (var3.17), the plastic material has a thermal stability that depends on [type of diamine/triamine?]

In another exemplary variation (var3.18), the plastic material further comprises a colorant.

In another exemplary variation (var3.19) of var3.18 the colorant affects a tensile strength of the plastic material.

In another exemplary variation (var3.20) of var 3.19, the plastic material of may be formed into a composite plastic material comprising an arrangement of a plurality of regions, each of which has zero or more colorants.

In another exemplary variation (var3.21) of var 3.20, the arrangement and color of the plurality of regions affects a tensile strength of the composite plastic material.

In a fourth exemplary embodiment (var4.1) related to the method of making PDK1.4, a method for making a heat resistant PDK plastic material comprises: (a) providing a triketone in liquid form; (b) mixing the liquid triketone with a difunctional polyamine that acts as a chain extender; and (c) adding a trifunctional polyamine to the mixture of step (b).

In one exemplary variation (var4.2), the triketone is TK10.

In another exemplary variation (var4.3), the difunctional polyamine is D230.

In another exemplary variation (var4.4), the trifunctional polyamine acts as a cross-linking agent.

In another exemplary variation (var4.5) of var 4.4, the trifunctional polyamine is an oxygen-centered primary amine.

In another exemplary variation (var4.6), of var 4.4, the trifunctional polyamine is a secondary amine.

In another exemplary variation (var4.7) of var 4.4, the trifunctional polyamine is T403.

In another exemplary variation (var4.8), the method comprises the step (d) of adding a plasticizer after step (c).

In another exemplary variation (var4.9) of var 4.8, the plasticizer is 5 mol % poly(tetrahydrofuran)bis(2-aminopropyl ether) (pTHF).

In another exemplary variation (var4.10), the method further comprises the step (c′) of stacking polyamines to adjust crystallization and glass transition temperatures of the PDK plastic material.

In an alternative characterization of a method variation for making PDK 1.3 (var 4.11), a method for making a heat resistant PDK plastic material comprising the following steps: providing a triketone; adding a solvent to the triketone, creating a first mixture; heating the first mixture so that it becomes liquid; adding a diamine that acts as a chain extender to the heated first mixture, creating a second mixture; and adding a trifunctional polyamine to the second mixture to form a polymer.

In another exemplary variation (var4.12) of var 4.11, the first mixture is heated to 90° C.

In another exemplary variation (var4.13), of var 4.12, the method further comprises maintaining the second mixture at 90° C. for five minutes.

In a fifth exemplary embodiment (var5.1) related to PDK1.3, a method for recovering monomers and additives from a PDK plastic material made from at least one triketone and at least one diamine that acts as a chain extender and one primary amine that acts as a cross-linking agent, comprising the steps of: adding the PDK plastic material to an acidic solution; heating the combination of the PDK plastic material and the acidic solution; stirring the combination of the PDK plastic material and the acidic solution; cooling the combination of the PDK plastic material and the acidic solution; after a biphasic mixture has formed, separating the two phases from each other; and recovering the at least one triketone, the at least one diamine, and the at least one primary amine from the two phases.

In a sixth exemplary embodiment (var6.1) related to using friction welding with PDK compositions, systems, and methods described herein, a method for joining two pieces of PDK plastic comprising the steps of: placing the two pieces of PDK plastic in contact with each other at a junction; adding heat to the junction via friction welding the junction, wherein the heat activates a dynamic amine exchange between the two pieces without causing the two pieces to melt.

In a seventh exemplary embodiment (var7.1) related to implementing pressing processes with compositions, systems, and methods described herein, a method for forming a molded piece of PDK plastic, comprising the steps of: (a) filling a mold with powdered PDK plastic; (b) heating the powered PDK plastic until it becomes sticky; (c) pressing and heating the powdered PDK plastic until it becomes a solid piece of PDK plastic; and (d) further pressing the solid piece of PDK plastic to remove surface defects.

In one exemplary variation (var7.2), step (b) is performed at 150° C. for 5-10 seconds.

In another exemplary variation (var7.3), step (c) is performed at 20,000 psi at 150° C. for 5 minutes.

In another exemplary variation (var7.4), step (d) is performed at 25,000 psi for 2 minutes.

1.-77. (canceled)

78. An eyewear frame made from a PDK polymer comprising:
a triketone; and
a heat resistant difunctional or trifunctional polyetheramine that forms dynamic covalent bonds with the triketone;
wherein the eyewear frame includes two components welded together and a wire inserted into at least one of the components.

79. The eyeglass frame of claim 78 comprising a molar excess of polyamine in relation to available triketone functional groups.

80. The eyewear frame of claim 79 wherein the PDK exhibits a faster stress relaxation at temperatures greater than Tg than the same PDK in the absence of excess polyamine.

81. The eyewear frame of claim 78 wherein the Tg is between 30 and 115° C.

82. The eyewear frame of claim 78 wherein the PDK has a Young's modulus of greater than 1 GPa.

83. The eyewear frame of claim 78 wherein the PDK has an elongation to break of greater than 25%.

84. The eyewear frame of claim 78 wherein the PDK comprises at least one of heat stabilizers, light stabilizers, plasticizers, rheology modifiers, flame retardants, and colorants.

85. The eyewear frame of claim 78 wherein the PDK does not degrade or decompose at a temperature greater than 200° C.

86. The eyewear frame of claim 78 wherein the eyeglass frame is laser engraved and or laminated.

87. A difunctional or trifunctional ketone produced by acid hydrolysis of the eyewear frame of claim 78.

88. The eyewear frame of claim 78 exhibiting at least one of:
a. a Young's modulus greater than 1 GPa;
b. an elongation to break of greater than 25%;
c. a Tg in the range of 30 to 115° C.; and
d. a decomposition or degradation temperature >200 C.

89. A method for making a heat resistant PDK plastic material, the method comprising:
combining a triketone with a difunctional or trifunctional polyetheramine in the presence of a molar excess of the polyamines to produce the PDK plastic material; and
producing an eyewear frame from the PDK plastic material.

90. The method of claim 89 wherein the PDK plastic material is produced by at least one of ball milling and solvent-based polymerization and is then followed by reactive extrusion or compression molding.

91. The method of claim 89 wherein the PDK plastic material is formed into a sheet or pellet.

92. The method of claim 91 wherein one or more components of the eyewear frame is machined from the sheet.

93. The method of claim 89 comprising:
providing a triketone;
adding a solvent to the triketone;
heating the triketone and the solvent so that the combination becomes liquid, creating a first mixture;
adding a molar excess of difunctional or trifunctional polyamine to the first mixture, creating a second mixture, wherein the second mixture includes residual solvent and water; and
heating the second mixture to remove the residual solvent and form the PDK plastic material.

94. The method of claim 89 wherein the eyewear frame is injection molded.

95. The method of claim 89 wherein the polymer has at least one of:
a. a Young's modulus greater than 1 GPa;
b. an elongation to break of greater than 25%;
c. a Tg in the range of 30 to 115° C.; and
d. a decomposition or degradation temperature >200 C.

96. The method of claim 89 comprising inserting a wire into the eyewear frame.

97. The method of claim 89 comprising welding a first component of the eyewear frame to a second component of the eyewear frame.

98. The method of claim 89 wherein the polyetheramine comprises a trifunctional or difunctional oxygen centered primary amine.

99. The method of claim 89 comprising adding at least one of heat stabilizers, light stabilizers, plasticizers, rheology modifiers, flame retardants, and colorants.

100. The method of claim 89 comprising:
filling a mold with the PDK plastic in a powdered form;
heating the powdered PDK plastic until it becomes sticky;
pressing and heating the powdered PDK plastic until it becomes a solid piece of PDK plastic; and
further pressing the solid piece of PDK plastic to remove surface defects.

101. The method of claim 89 comprising producing a triketone via acid hydrolysis of the eyewear frame.
